(19) United States
(12) Patent Application Publication
(10) Pub. No.: US 2012/0212091 A1
(43) Pub. Date: Aug. 23, 2012

(54) Electric machine

(76) Inventor: Paul Andrew Schaafsma, Noank, CT (US)

(21) Appl. No.: 12/932,235

(22) Filed: Feb. 22, 2011

(51) Int. Cl. H02K 7/116

(52) U.S. Cl. 310/83

(57) ABSTRACT

An electric machine in accordance with the principles of the present invention comprises a rotor having rotor coils, a stator having stator coils, and a rotatable shaft. The rotor rotor is circular and includes at least one torque transmitter in the form of at least one bevel gear contained thereon. The stator is circular and is operatively positioned relative to the rotor, the rotor coils and the stator coils causing the rotor to rotate relative to the stator. The rotatable output shaft has defined thereon a torque transmitter in the form of a bevel gear contained thereon. The rotatable output shaft bevel gear engages the at least one rotor bevel gear. Thus, an electric machine in accordance with the principles of the present invention has removed a standard electronic machine internal connection to leave the internal section formerly compromising the connective sections open.

### FIELD OF THE INVENTION

The present invention relates to electric machines.

### BACKGROUND OF THE INVENTION

An electric motor converts electrical energy into mechanical energy. Electric motors operate through interacting magnetic fields and current-carrying conductors to generate force. The reverse process, producing electrical energy from mechanical energy, is done by generators. Electric motors and generators are commonly referred to as electric machines.

As early as 1821, the physical principle of production of mechanical force by the interactions of an electric current and a magnetic field was known: in 1821, British scientist Michael Faraday demonstrated the conversion of electrical energy into mechanical energy by electromagnetic means. A free-hanging wire was dipped into a pool of mercury, on which a permanent magnet was placed. When a current was passed through the wire, the wire rotated around the magnet, showing that the current gave rise to a close circular magnetic field around the wire.

In 1827, Hungarian physicist Anyos Jedlik started experimenting with devices he called electromagnetic self-rotors. Although they were used only for instructional purposes, in 1828 Jedlik demonstrated the first device to contain the three main components of practical direct current motors: the stator, rotor, and commutator. The rotor is the non-stationary part of the electric machine; the stator is the stationary part. The commutator is a rotary electrical switch that periodically reverses the current direction between the rotor and the external circuit. The device employed no permanent magnets, as the magnetic fields of both the stationary and revolving components were produced solely by the currents flowing through their windings.

In 1832, British scientist William Sturgeon invented the first commutator-type direct current electric motor capable of turning machinery. In 1837, Americans Emily and Thomas Davenport built a commutator-type, direct-current electric motor made with the intention of commercial use. Their motors ran at up to 600 revolutions per minute and powered machine tools and a printing press; however, the Davenports' motors were commercially unsuccessful. In 1855, Ányos Jedlik built a device using similar principles to those used in his electromagnetic self-rotors that was capable of useful work. Jedlik built a model electric motor-propelled vehicle that same year. In 1873, Belgian electrical engineer Zénobe Gramme invented the modern direct current (DC) motor by accident, when he connected the dynamo he had invented to a second similar unit, driving it as a motor. This Gramme machine was the first electric motor that was successful in industry.

In 1886, American naval officer Frank Julian Sprague, known as the “Father of Electric Traction”, invented the first practical DC motor, a non-sparking motor capable of constant speed under variable loads. In 1887-88, Sprague used electric motors to implement the first electric trolley system in Richmond, Va. In 1892, Sprague developed the electric elevator and control system and the electric subway with independently powered centrally controlled cars, which was first installed in 1892 in Chicago.

In 1888, Serbian inventor Nikola Tesla invented the first practicable alternative current (AC) motor. In 1890, Russian inventor Michail Osipovich Dolivo-Dobrovolsky invented a three-phase “cage-rotor” AC motor. This type of motor is now used for the majority of commercial applications.

Today, electric motors are found in applications as diverse as motor vehicles; ships; hydraulic pumps; industrial fans, blowers and pumps; machine tools; household appliances; power tools; and disk drives, to name a few. Electric motors may be powered by direct current (e.g., a battery powered device) or by alternating current from an electrical distribution grid. There exist a multiplicity of different electric motor types, but each suffers disadvantages. In AC polyphase induction squirrel-cage motors starting inrush current can be high, and speed control requires variable frequency source. Shaded-pole motors suffer from rotation slips from frequency, low starting torque, and low efficiency. AC Induction motors also suffer from rotation slips from frequency and a starting switch is required. Universal motors have issues with maintenance (brushes) lifespan and are only economic in small ratings. AC Synchronous motors are quite expensive. Stepper DC motors and brushless DC motors have a high initial cost and require a controller. Brushed DC motors have issues with maintenance (brushes) lifespan and utilize costly commutator and brushes. Pancake DC motors are costly and do not have a long lifespan. What would therefore be desirable would be a low cost, long life, high efficiency, low maintenance, high torque electric machine design.

### SUMMARY OF THE INVENTION

An electric machine in accordance with the principles of the present invention delivers a low cost, long life, high efficiency, low maintenance, high torque design. An electric machine in accordance with the principles of the present invention comprises a rotor having rotor coils, a stator having stator coils, and a rotatable shaft. The rotor rotor is circular and includes at least one torque transmitter in the form of at least one bevel gear contained thereon. The stator is circular and is operatively positioned relative to the rotor, the rotor coils and the stator coils causing the rotor to rotate relative to the stator. The rotatable output shaft has defined thereon a torque transmitter in the form of a bevel gear contained thereon. The rotatable output shaft bevel gear engages the at least one rotor bevel gear. Thus, an electric machine in accordance with the principles of the present invention has removed a standard electronic machine internal connection to leave the internal section formerly compromising the connective sections open.

### BRIEF DESCRIPTION OF THE DRAWINGS

FIG. 1 shows an exploded view of an electric machine in accordance with the principles of the present invention.

FIG. 2 shows an exploded view of the electric machine of FIG. 1 partially cut away.

### DETAILED DESCRIPTION OF THE INVENTION

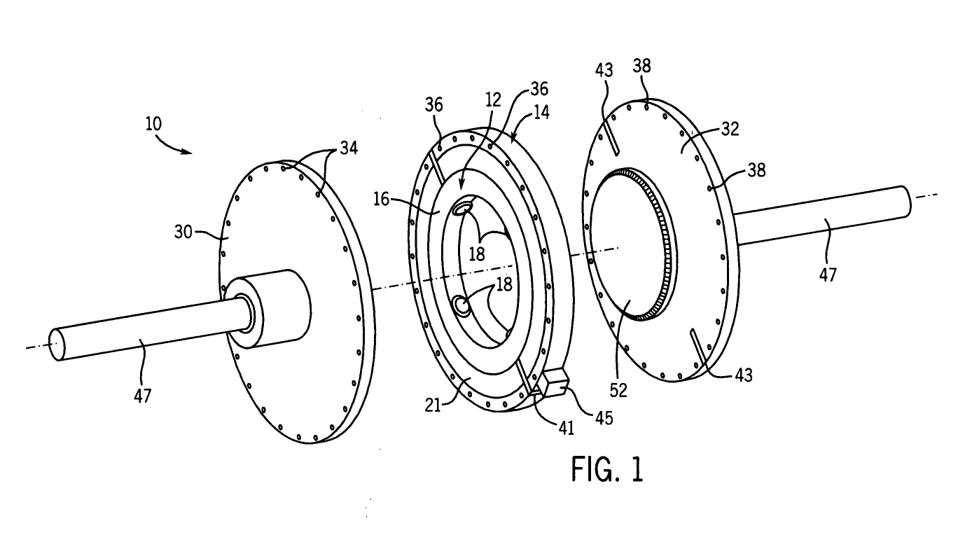

In accordance with the principles of the present invention, a low cost, long life, high efficiency, low maintenance, high torque electric machine is provided. Referring to FIG. 1, an exploded view of an electric machine in accordance with the principles of the present invention is seen. In this example description, the electric machine is an electric motor 10. The electric motor 10 includes a rotor 12 and a stator 14. The rotor 12 comprises a rotor casing 16 having rotor coils 23 contained therein, as detailed below. The rotor casing 16 comprises a circular ring having a torque transmitter 18. In one embodiment the torque transmitter can be at least one bevel gear contained thereon. The stator 14 comprises a stator casing 21 having stator coils 25 contained therein, as detailed below. The stator casing 21 can be segmented into two sections to allow for easy assembly/disassembly and maintenance. The stator casing 21 also comprises a circular ring that is operatively positioned relative to the rotor 12; in the embodiment described herein, the rotor 12 is contained within the stator 14.

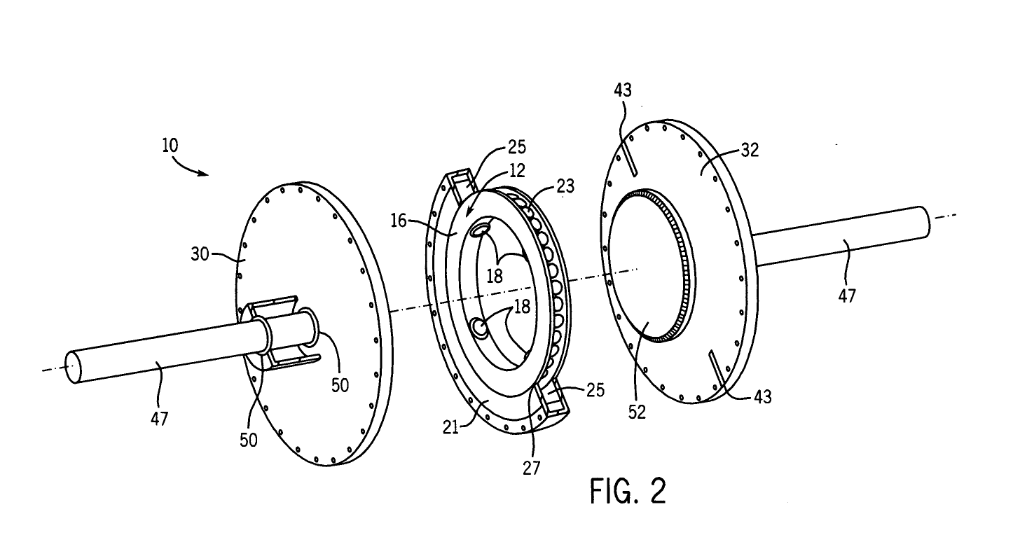

Referring to FIG. 2, an exploded view of the electric motor of FIG. 1 partially cut away is seen. The rotor coils 23 are contained within the rotor casing 16. The stator coils 25 are contained within the stator casing 21. In one embodiment, the stator coils 25 and the rotor coils 23 can be a simple induction series composed of typical North/South wiring patterns. In one embodiment, the stator coils 25 be three-phase or capacitor start single phase configuration. Bearings 27 are provided to allow constrained relative motion between the rotor casing 16 and the stator casing 21; in one embodiment, the bearings 27 can comprise sleeve bearings, with the stator casing 21 containing one side of the bearing surface and the rotor casing 16 containing the cooperating bearing surface. Internal lubricant can also be provided.

Referring back to FIG. 1, the rotor casing 16 and the stator casing 21 can be secured between bell housing plates 30, 32 to contain the internal lubricant. The first bell housing plate 30 defines a plurality of mounting holes 34 that cooperate with like mounting holes 36 defined in the stator casing 21 and mounting holes 38 defined in the second bell housing plate 32 to enable fasteners to secure the assembly. Optionally to further secure and stabilize the bell housing plates 30, 32 and the stator casing 21, the stator casing 21 can further define at least one flange 41 that is secured in a flange notch 43 defined in the bell housing plates 30, 32; of course, the positioning of the flange 41 and flange notch 43 can be reversed. An electrical connection 45 can be provided to power the motor (or in the case of a generator, to provided power from the electric machine).

Secured within an aperture defined on at least one of the bell housing plates 30, 32 is a rotatable output shaft 47. Referring to FIG. 2, bearings 50 are provided to allow rotational motion between the rotateable output shaft 47 and the bell housing plate 30; in one embodiment, the bearings 50 can comprise bevel bearings. Defined on the inner end of the rotatable output shaft 47, to operatively interact with the rotor casing 16, is a cooperating a torque transmitter 52. In one embodiment, this cooperating torque transmitter 52 can be a bevel gear. When secured together in use, the at least one torque transmitter 18 on the rotor casing 16 is operably engaged with the cooperating torque transmitter 52 to drive the at least one driveshaft 47. Thus, an electric machine in accordance with the principles of the present invention has removed the standard electronic machine internal connection and replaced with a bearing surface between the rotor and stator sections. This design leaves the internal section formerly compromising the connective sections open and leaves an area free for other items.

While the invention has been described with specific embodiments, other alternatives, modifications and variations will be apparent to those skilled in the art. For example, while the presently described example of an electric machine in accordance with the principles of the present invention depicts an electric motor, the principals of the present invention apply to generators as well. Accordingly, it will be intended to include such alternatives, modifications and variations within the spirit and scope of the appended claims.

What is claimed is:

1. An electric machine comprising:
a rotor having rotor coils, the rotor being circular and having at least one torque transmitter contained thereon;
a stator having stator coils, the stator being circular and being operatively positioned relative to the rotor, the rotor coils and the stator coils causing the rotor to rotate relative to the stator; and
a rotatable shaft having defined thereon a torque transmitter, the rotatable output shaft torque transmitter engaging the at least one rotor torque transmitter;
whereby the electric machine has removed a standard electronic machine internal connection to leave the internal section formerly compromising the connective sections open.

2. The electric machine of claim 1 further wherein the rotor comprises a rotor casing having rotor coils contained therein.

3. The electric machine of claim 1 further wherein the torque transmitter on the rotor comprises at least one bevel gear.

4. The electric machine of claim 1 further wherein the cooperating torque transmitter on the rotatable shaft comprises a bevel gear.

5. The electric machine of claim 1 further wherein the stator coils comprise three-phase coils.

6. The electric machine of claim 1 further wherein the rotor coils comprise three-phase coils.

8. The electric machine of claim 1 further wherein the rotor and the stator are secured between bell housing plates.
